(19) United States
(12) Patent Application Publication
(10) Pub. No.: US 2003/0208574 A1
(43) Pub. Date: Nov. 6, 2003

(54) Method for previewing MIB group table in SNMP network device

(76) Inventors: Yung-Hsin Chen, Hsinchu (TW); Yu-Min Yan, Hsinchu (TW); Ming-Chih Chang, Hsinchu (TW); Chun-Chieh Huang, Hsinchu (TW)

Correspondence Address: BACON & THOMAS, PLLC, 625 SLATERS LANE, FOURTH FLOOR, ALEXANDRIA, VA, 22314

(21) Appl. No.: 10/026,622

(22) Filed: Dec. 27, 2001

(51) Int. Cl. G06F 15/173

(52) U.S. Cl. 709/223

(57) ABSTRACT

A method for previewing a MIB (Management Information Base) group table in a SNMP (Simple Network Management Protocol) network device comprises transmitting a packet having preview facility from a NMS (Network Management Station) to the network device; after the network device has received the packet, transmitting items in the MIB group table which supports the SNMP back to the NMS in a reply packet; and enabling the NMS to perform an analysis on the reply packet so as to preview items of the MIB group table in the network device which support SNMP.

### FIELD OF THE INVENTION

The present invention relates to network and more particularly to a method for previewing MIB group table in SNMP network device.

### BACKGROUND OF THE INVENTION

In the recent years, the World Wide Web is rapidly expanded to all over the world and lots of new network devices have been developed and used in our work places and daily life. This trend not only facilitates information communication and increases efficiency, but also let our life be more comfortable and let our work be more productive. However, lots of the network devices also bring lots of problems for the network management employees on how to effectively manage the various network devices.

With respect to many enterprises using LAN (local area network) or the Internet as a tool for information communication within the enterprise, for enabling network management employees to effectively manage various network devices or network agents, a SNMP (Simple Network Management Protocol) is usually employed. Thus, NMSs (Network Management Stations) are capable of setting and managing the SNMP based network devices. SNMP permits a network management employee to access network from a remote computer and access a setting window on the SNMP network device so as to set, modify, and manage the same. But a network management employee has to know an exact IP address of each network device prior to accessing the setting window on the SNMP network device. Further, one SNMP network device is not allowed to have the same address as another SNMP network device. Hence, a network management employee has to know a predetermined IP address of each SNMP network device as well as be capable of setting and managing IP.

Moreover, as shown in FIG. 1, traditionally a network management employee simply has three basic commands, e.g., SnmpGet (i.e., read MIB (Management Information Base)), SnmpSet (i.e., set MIB), and GetNext (i.e., read a next MIB) in managing SNMP network device through network by employing SNMP based tools. Further, there are no useful commands available other than the above three. As such, with respect to MIB contents provided by all SNMP network devices, almost all network management employees and MIB tool developers can know items available from MIB only by reading MIB files. In other words, almost all network management employees and MIB tool developers utilize above three commands and/or combinations thereof to achieve the purpose of network management. However, with respect to the MIB tool developers, those tools developed from the commands and/or combinations thereof do not produce a preferred performance in network management for those SNMP network devices. Particularly, all of the current MIB tools are not capable of determining in advance whether MIB containing items which support SNMP with respect to all network devices. Also, it is impossible to determine in advance, through the provided MIB files, whether MIB of network device containing items which support SNMP. Moreover, the RFC specifications provide sufficient MIB contents, however such network device may only support a few functions or several items of certain group table. In this case when MIB browser is utilized to read (or set) MIB, a read (or set) failure problem may occur due to no presence of supported SNMP items in the group table. Till now, there isn't any effective technique proposed by MIB tool developers for solving the above problem.

Conventionally, when MIB tool is employed by NMS to transmit signal of SnmpGet or SnmpSet to a certain group table in MIB of a network device for reading or setting MIB, the whole group table is viewed as supporting SNMP. However, a no OID (object identifier) error message will be displayed if the network device can only support certain functions or no SNMP support is available in certain items thereof. Further, only the first unsupported SNMP item is known. Thus, a try and error method is required to track error until all unsupported SNMP items are found. By only utilizing this, a correct MIB reading or setting is then achieved.

Thus, it is desirable to provide a method for quickly finding out all unsupported items, simplifying setting and management of network device, shortening operating time, and enabling a manager to quickly and easily manage the geographically apart network devices in order to overcome the above drawbacks of prior art.

### SUMMARY OF THE INVENTION

It is therefore an object of the present invention to provide a method for previewing a MIB (Management Information Base) group table in a SNMP (Simple Network Management Protocol) network device, prior to enabling a NMS (Network Management Station) to read or set with respect to one of the MIB group tables in at least one SNMP network device. The method comprises transmitting a packet having preview facility from the NMS to the network device; after the network device has received the packet, transmitting items in the MIB group table which supports the SNMP back to the NMS in a reply packet; and enabling the NMS to perform an analysis on the reply packet so as to preview items of the MIB group table in the network device which support SNMP. By utilizing this method, it is possible of eliminating the conventional try and error method in tracking error. Also, a network management employee can utilize MIB browser or any of other MIB tools to perform an effective management on the network devices so as to greatly decrease the chances of reading or setting failure, resulting in a correct MIB reading or setting.

The above and other objects, features and advantages of the present invention will become apparent from the following detailed description taken with the accompanying drawings.

### BRIEF DESCRIPTION OF THE DRAWINGS

FIG. 1 presents schematically a network mode employed by a conventional SNMP based MIB tool for managing a SNMP based network device;

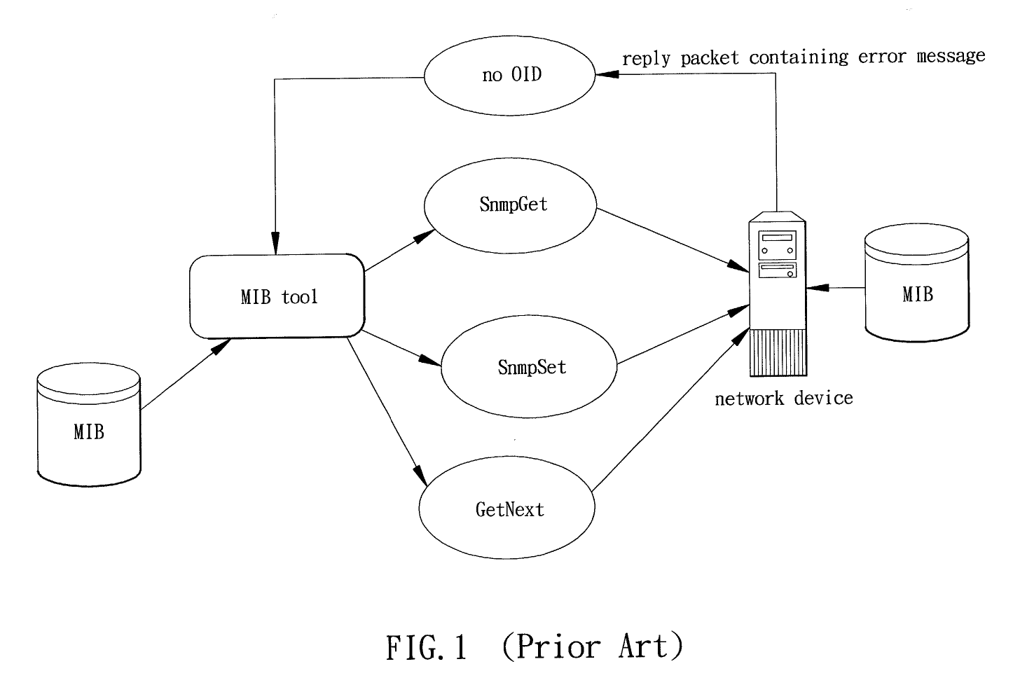

FIG. 2 presents schematically a network mode employed by a method of the invention for managing a SNMP based network device;

FIG. 3 depicts a window for previewing whether there are system group items complied with RFC.1213 specifications made available from a certain network device according to a first preferred embodiment of the invention; and

FIG. 4 depicts another window for previewing whether there is ipRouteTable item complied with RFC.1213 specifications made available from a certain network device according to a second preferred embodiment of the invention.

### DETAILED DESCRIPTION OF THE PREFERRED EMBODIMENTS

In the current network field, a variety of network devices are utilized in the field, therefore information provided by MIB in network device has become more diverse and complex. In case that SNMP in a network device provides a mechanism which only contains the above mentioned three conventional commands (i.e., SnmpGet, SnmpSet, and GetNext) without further improvements, the functions of network management is obviously not sufficient to meet with the developing trend of the current network field. Thus, it is desirable to have a mechanism in a SNMP network device capable of previewing so that NMS can preview the truly supported SNMP items in MIB group table of SNMP network device through the mechanism. As such, only one transmission and receiving of packet is sufficient to preview the truly supported SNMP items in SNMP network device. Then in a next transmission and receiving it is possible of correctly managing the network device. For network management employees and MIB program developers, if there is a mechanism available from SNMP network device capable of previewing the truly supported SNMP items in MIB, a convenient and effective MIB tool can be thus developed.

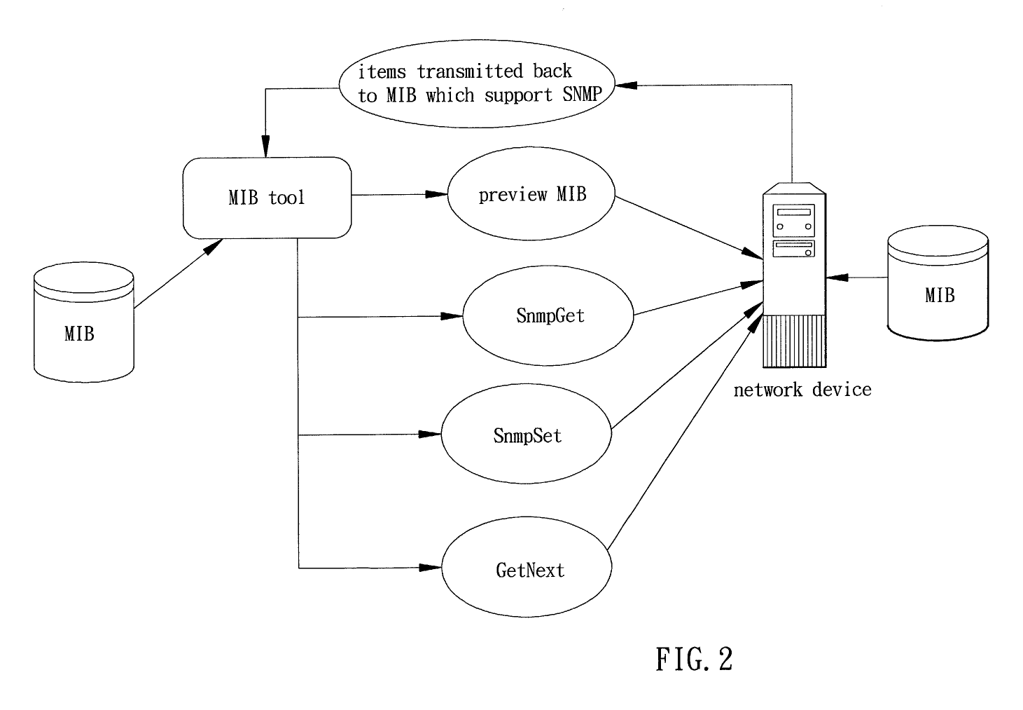

Referring to FIG. 2, according to the invention, when MIB browser (or MIB tool) on NMS is utilized by network management employee to effect an effective management on various network devices over network so as to decrease the chances of reading (or setting) failure, MIB browser (or MIB tool) is required to have a preview facility. The preview facility is effected through SNMP. In detail, a packet having preview facility is transmitted from NMS to network device. After network device has received the packet, the items supported by MIB will be transmitted back to MIB browser (or MIB tool) in a form of group table. Hence, NMS may know the items supported by network device from the group table. In the invention, when MIB tool transmits a signal of SnmpGet (or SnmpSet) to a MIB group table for reading (or setting), it is required to transmit a packet having preview facility in advance. Then, perform an analysis on a reply packet in order to skip the unsupported items as well as eliminate the conventional try and error method in tracking error so as to perform a correct MIB reading or setting.

The preview facility is associated with MIB group table of each SNMP network device for enabling SNMP network device to inform NMS in advance of MIB items, which truly support SNMP in MIB group table. As such, for MIB tool development engineers, the above mechanism may be utilized to develop a reliable and user friendly software tool with respect to MIB browser (or any of other MIB tools). The conventional MIB tools currently available in the market, in accessing the whole MIB group table of a SNMP network device to achieve the above-mentioned mechanism, can only use GetNext command to read the items one by one and determine whether there is the truly supported SNMP item in the whole MIB group table. It is impossible for the conventional MIB tools to determine the truly supported SNMP item in the whole MIB group table by one action. Further, in some cases it is impossible to correctly determine whether every OID item has been performed if there is no group table being procured. In contrast, the invention simply transmits a packet having preview facility one time for achieving the purpose of knowing items in group table supported by SNMP network device in the reply packet. Next, it is possible to correctly read or set MIB in subsequent processes. It is understood that a conventional MIB tool has to perform N times in accessing the whole group table. In comparison, by utilizing a preview facility of the invention, there are only two times of actions for achieving the same purpose. In view of the above, the invention is advantageous over prior art MIB tool with respect to efficiency.

In the invention, SNMP is utilized to transmit or receive packets. Also, a packet having preview facility has to not only comply with SNMP transmission/receiving rules but also comply with the transmission/receiving formats defined by the invention as follows:

When NMS transmits a packet having preview facility, which complies with SNMP, an OID string will be carried at the same time. The OID string is required to be OID of MIB group table or entry OID of MIB group table (i.e., entry OID of certain MIB group table to be obtained).

When SNMP network device receives the packet having the preview facility, a reply packet will be transmitted back therefrom based on the preview facility of packet. The reply packet has the following PDU format:

| | |
|---|---|
| PDU variable length (N) | PDU variable bit string |

where PDU variable length is an integer (i.e., contents at head portion of standard PDU), and PDU variable bit string is an octal digit string in a range of [1 . . . N], where N>=1.

In the above PDU format, if there are eight items supported by SNMP in a certain MIB group table, in which items 2, 5, and 6 are not supported in performing SNMP, then reply packet having preview facility may be written as one of following formats:

(1) First Format of PDU Variable Bit String:

| | | | | | | | |
|---|---|---|---|---|---|---|---|
| 1 | 0 | 1 | 1 | 0 | 0 | 1 | 1 |

, where eight functions are contained (i.e., eight bits are involved)

1: Represents an index in MIB group table which truly supports SNMP; and

0: Represents an index in MIB group table which does not support SNMP.

(2) Second Format of PDU Variable Bit String:

| | | | | |
|---|---|---|---|---|
| 1 | 3 | 4 | 7 | 8 |

, where five bits are used to store indices which support SNMP. Hence, a reply content comprises all indices which support SNMP.

(3) Third Format of PDU Variable Bit String:

| | | |
|---|---|---|
| 2 | 5 | 6 |

, where three bits are used to store indices in MIB group table which do not support SNMP. Hence, a reply contents comprises all indices which do not support SNMP.

(4) Fourth Format of PDU Variable Bit String:

11001101

, where one byte is used to store eight indices in MIB group table which support SNMP. Additional bytes need to be added to store a group table having more than eight indices. In such a manner, each bit represents an index. Also, bit corresponding to index which supports SNMP is set as one.

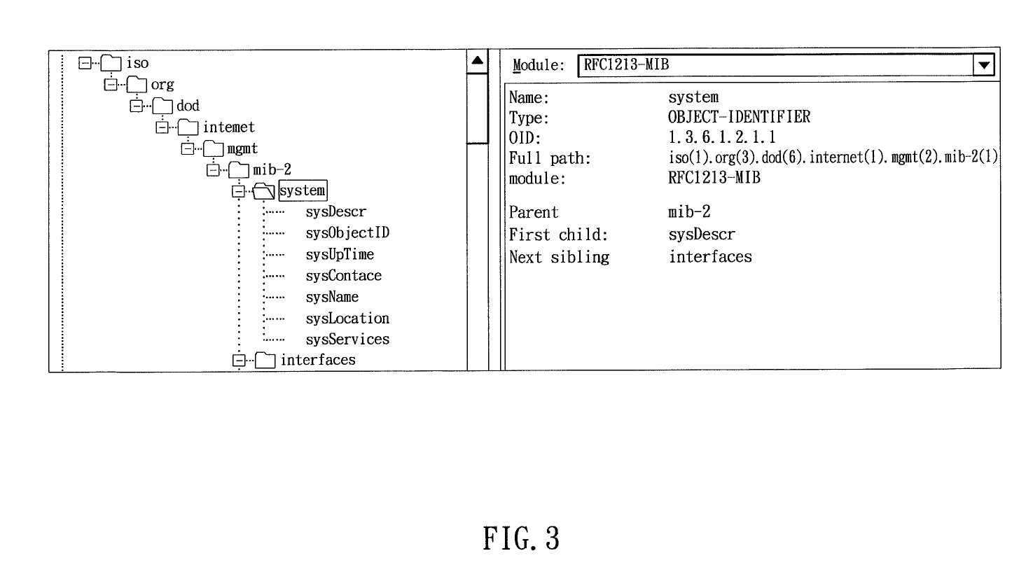

FIG. 3 depicts a first preferred embodiment according to the invention. If user desires to preview whether there are system group items complied with RFC.1213 specifications are provided by a certain network device, NMS first transmits a packet having preview facility complied with SNMP and carrying an OID value of the value 1.3.6.1.2.1.1 (i.e., system value). A reply packet is transmitted back based on the packet having preview facility when network device receives the packet having preview facility. The content of reply packet is a PDU variable bit string. Based on the above formats, NMS simply needs to transmit packet twice wherein first packet is used to preview indices in MIB group table of network device which support SNMP, and second packet is used to correctly read or set the network device. To the contrary, a conventional GetNext technique requires NMS to transmit packet seven times in order to correctly determine indices in network device, which support SNMP.

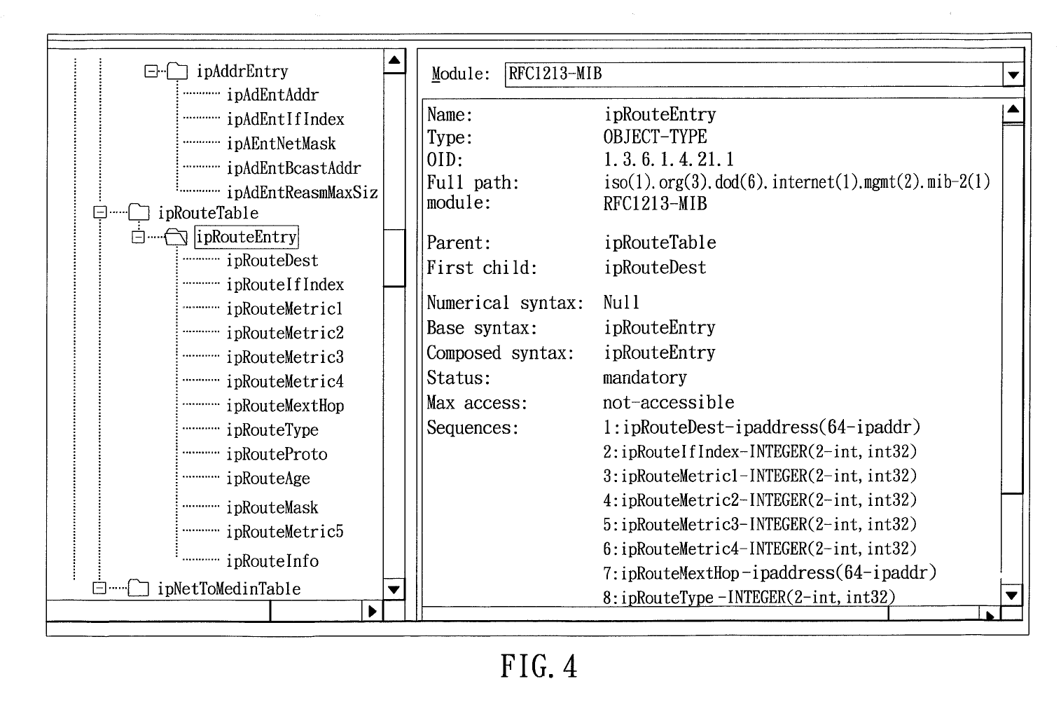

FIG. 4 depicts a second preferred embodiment according to the invention. If user desires to preview whether there is ipRouteTable item complied with RFC.1213 specifications provided by a certain network device, NMS first transmits a packet having preview facility complied with SNMP and then utilize an OID value (e.g., 1.3.6.1.2.1.4.2.1.1) of ipRouteTable as a transmission value. A reply packet is transmitted back based on the packet having preview facility when network device receives the packet having preview facility. The content of the reply packet comprises indices which support SNMP. To the contrary, a conventional SnmpGetNext technique requires NMS to transmit packet more than ten times in order to correctly determine indices in network device, which support SNMP.

In brief, by utilizing the method of the invention NMS can preview indices of group table in network device, which support SNMP. If a further management of network device is desired, user can use MIB browser to directly access each network device for setup. This can effect an efficient setting process. Hence, for managing a large number of network devices over network method of the invention can significantly decrease time spent on transmitting, receiving, and determining packets. As a result, MIB tool is more user-friendly, thereby greatly improving network management efficiency.

While the invention has been described by means of specific embodiments, numerous modifications and variations could be made thereto by those skilled in the art without departing from the scope and spirit of the invention set forth in the claims.

What is claimed is:

1. A method for previewing a MIB (Management Information Base) group table in a SNMP (Simple Network Management Protocol) network device, prior to enabling a NMS (Network Management Station) to read or set with respect to one of the MIB group tables in at least one SNMP network device, the method comprising:
transmitting a packet having preview facility from the NMS to the network device;
after the network device has received the packet, transmitting items in the MIB group table which supports the SNMP back to the NMS in a reply packet; and
enabling the NMS to perform an analysis on the reply packet so as to preview items of the MIB group table in the network device which support SNMP.

2. The method of claim 1, wherein a transmission or receiving of the packet having preview facility is effected by the SNMP, and the packet has a format complied with a SNMP transmission or receiving rule and an OID (object identifier) string carried therewith which is an OID of the MIB group table.

3. The method of claim 2, wherein the OID string is an entry OID of the MIB group table.

4. The method of claim 1, wherein the reply packet has a PDU based format including a first field of PDU variable length and a second field of PDU variable bit string where the PDU variable length is an integer as contents at a head portion of a standard PDU, and the PDU variable bit string is a string of digit in a range of [1 . . . N], where N>=1.

5. The method of claim 4, wherein the second field of PDU variable bit string comprises a plurality of cells for storing either 1 or 0, and wherein 1 represents an index in the MIB group table which truly supports the SNMP, and 0 represents an index in the MIB group table which does not support the SNMP.

6. The method of claim 4, wherein the second field of PDU variable bit string comprises a plurality of cells for storing all of the indices which support the SNMP.

7. The method of claim 4, wherein the second field of PDU variable bit string comprises a plurality of cells for storing all of the indices which do not support the SNMP.

8. The method of claim 4, wherein the second field of PDU variable bit string comprises one byte for storing the indices in the MIB group table which support the SNMP, and wherein each bit of the byte represents an index and a bit corresponding to an index which supports the SNMP is set as 1.
